(19) United States
(12) Patent Application Publication
(10) Pub. No.: US 2006/0015765 A1
(43) Pub. Date: Jan. 19, 2006

(54) Method for synchronizing a distributed system

(76) Inventors: Mirko Jekal, Tostedt (DE); Gerald Schreiber, Wentorf (DE); Christoph Steinbruck, Hamburg (DE); Stefan von der Heide, Norderstedt (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/183,579

(22) Filed: Jul. 18, 2005

(30) Foreign Application Priority Data
Jul. 19, 2004 (EP) 04017035.9

(51) Int. Cl. G06F 11/00

(52) U.S. Cl. 714/4

(57) ABSTRACT

The invention relates to a method for synchronizing components of a distributed system. The system status is represented by at least one object which is provided in all components. A change of the status of the object in one of the components is signalled to all other components by means of a status change message. The local validity of the signalled status change is checked by each of the other components, with the locally valid status change of the status of the objects in these components is updated and, with for locally invalid status change a component with valid status of the object is determined, which is sent to at least with invalid status of the object, at which point the status of the object is updated in these components. The invention further relates to a distributed system of which the components are embodied to execute the method. By contrast with the known distributed systems the present invention offers the advantage, that for transmission of the status change messages which are needed to maintain or restore the system synchronicity, insecure and thereby fast data transmission methods can be used, for example UDP multicast messages.

### CROSS REFERENCE TO RELATED APPLICATIONS

This application claims priority to the European application No. 04017035.9, filed Jul. 19, 2004 and which is incorporated by reference herein in its entirety.

### FIELD OF INVENTION

The present invention relates to the synchronization of a distributed system and especially to the distribution of data as well as to the access to resources in distributed systems.

### SUMMARY OF INVENTION

In order to handle complex computing tasks and/or to create security in data processing systems through redundancy, systems are frequently used which are a combination of a plurality of individual automation units of computing units or computer systems which however present themselves to the user of the system transparently as a single system. Such systems are referred to as distributed systems in which for example procedures or measures such as memory redundancy or load balancing are preferably designed so as to be transparent, i.e. imperceptible to the user. Distributed systems are distinguished from a networks for example by the fact that in networks the individual computers of the network are presented to the user as separate entities, with memory redundancy or load balancing frequently not being arranged transparently, that is perceptible to the user, and frequently even requiring user interaction.

In distributed systems data must be distributed between the individual computing machines or systems. There are a number of known options for this data distribution. Generally a distinction is to be made here between the relatively slow transaction-based data transmission on the one hand and the faster, relatively more insecure distribution with less effort on the other hand.

When, in the case of transaction-secured, data transmission the transaction security extends to the user interface, a complete data consistency at all times can be ensured in that for example the use only receives an acknowledgment if an entry has been distributed secured in the system. This is however a relatively tedious process with a high communication overhead, especially in cases in which the data has to be distributed over many machines. While long reaction times are generally undesirable there are any number of applications in which a long reaction times must be avoided, for example security-critical applications Furthermore transaction-based systems are complex to implement and expensive.

If on the other hand there is a departure from the principle of full transaction security, for example by an acknowledgment message being sent even if the input can only be forwarded to one other machine or another system, there is the danger of inconsistent states in the system These inconsistent states can lead to a loss of data, in cases, such as where system separations occur as a result of connection problems or the very machines or subsystems fail which have received the input data. As a result a signal could be sent to a user that his input had been processed whereas this input has been lost in the system, something which must specifically not occur in security-critical environments.

A typical example is an emergency call which is then confirmed to the user making the call as a successfully issued emergency call by a display but which in the final analysis is not further processed.

The object of the present invention is thus to specify an alternative transmission method for distributed systems as well as an alternative distributed system where security of a complete transaction security is achieved with low outlay.

This object is achieved by a method for synchronizing components of a distributed system in accordance with which the system status is represented by at least one object that is provided in all components, with a change of status of the object in one of the components being signalled by a status change message to all other components, whereon the local validity of the signalled status change is checked by each of the other components, with, for a locally valid status change, the status of the objects in these components being updated and with, for a locally invalid status change, a component with a valid status of the object being determined which is at least sent to the components with the invalid status, whereon the status of the objects is updated in these components.

The invention further relates to a distributed system of which the components are designed for executing the inventive method.

By contrast with known distributed systems the present invention offers the advantage that for transmission of the status change messages which are needed to maintain the system synchronicity or to restore it, unsecured and thereby faster transmission methods can be used, for example UDP/IP (User Datagram Protocol/Internet Protocol) multicast messages. The requirement here is that these messages also reach their destination in the normal case and that the system remains synchronous through these messages alone. If however faults arise, each component is in a position at the latest by the next status change message received or with longer pauses in the message transmission by the monitoring mechanism used, to establish the where necessary local interruption of the synchronicity and to request this from a component with the correct status. The system status is in this case mapped completely by one or more objects. A number of suitably delimited objects offer the advantage here that the volume of data occurring for a change of status of one of the objects is smaller.

In other words the present invention achieves a loosely-coupled distributed system in which the normal operation without faults runs more quickly than in completely transaction-secured systems, whereas at the same time that the security of a completely transaction-secured system is guaranteed.

In this case it is not necessary in accordance with the invention to maintain information on the system status or on the status of the object in selected central components, e.g. servers or databases which would constitute what is known as the single point of failure. Instead, in the event of an error, a component is determined which has a valid status which can then be used for components with invalid object status. A “single point of failure” always dictated by central components which adversely affects the availability of the system is not required in accordance with the invention.

The present invention equally provides a mechanism for resolving competing accesses to exclusive resources. With such competing accesses it is necessary to set a consistent or synchronous systems state if two or more instances are simultaneously or contemporaneously manipulating an exclusive resource or attempting to do this. Here too an inconsistent status can be prevented or rectified by the present invention.

In many applications a distributed system in accordance with the invention can advantageously replace a separate database as well as a transport mechanism for distributed working (e.g. CORBA). Such a system also offers advantages in environments where from time to time network separations (separate subnetworks) with subsequent recombination occur. Here the system resets itself—imperceptibly for the user as a rule—back to a common status.

### BRIEF DESCRIPTION OF THE DRAWINGS

FIG. 1 shows in a schematic diagram a communication flow of status-related communication in a loosely-coupled system, and

FIG. 2 shows another schematic diagram comprising also a communication flow of status-related communication in a loosely-coupled system.

### DETAILED DESCRIPTION OF INVENTION

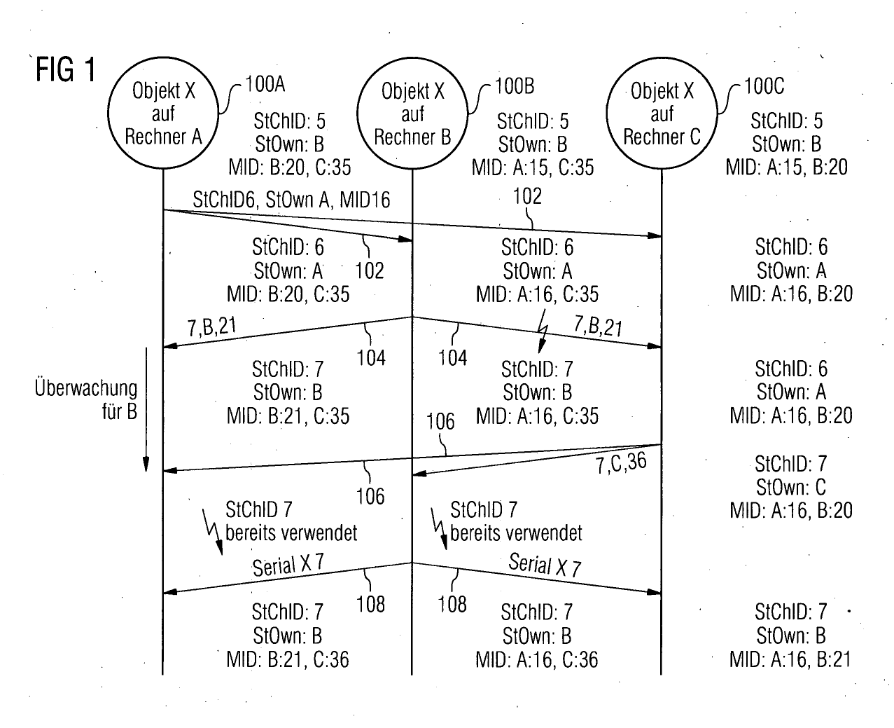

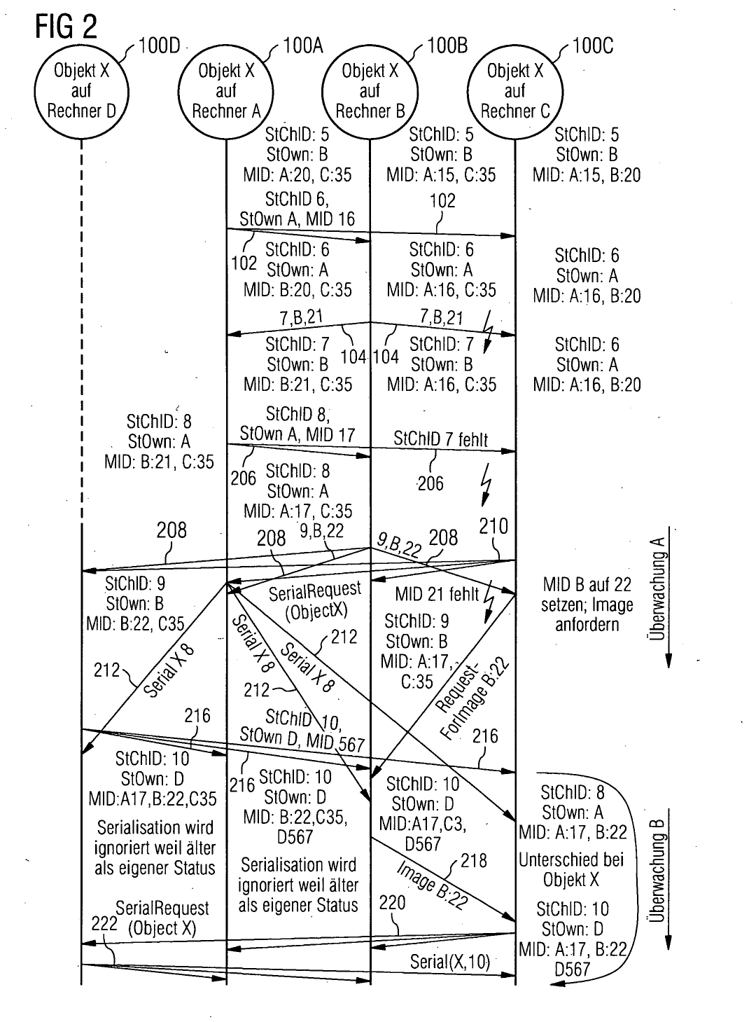

The invention is explained in more detail below in exemplary embodiments with reference to a drawing. FIGS. 1 and 2 show a schematic diagram, of the sequence of status-related communication in a loosely-coupled system with a number of components in conjunction with the handling of the transmission error.

FIG. 1 shows a schematic diagram of the communication sequence as regards an object X, which is mapped on three components A, B, C of a loosely-coupled system. This object mapping is represented by circles 100A, 100B, 100C for each of the three computers or computer systems A, B, C.

It is assumed that all three computers A, B, C have initially stored the same status for the object X, are therefore operating synchronously in relation to the object X. The status is characterized by what is known as the status owner (StOwn) and the identifier of the last status message (StChID). These two parameters are stored in all computers and are the same throughout the system for as long as the system is operating synchronously. Furthermore message identifications (MID) are stored in all other computers, in computer A therefore further message identifications of the computers B and C, in computer B further message identifications of the computers A and C and in computer C further message identifications of the computers A and B.

The computer in which the last status change occurred is designated as the status owner and which as a result of this status change has communicated with other computers by means of the status change message. In the present case: StOwn=B, i.e. Computer B is the status owner of the last status change which carries the identifier StChID=5. The last message sent out by A had the MID 15, the last message sent out by B had the MID 20 and the last message sent out by C had the MID 35, with the initial status shown in FIG. 1 producing the identifications associated with the status change messages.

As a result of a status change computer A then transmits to all other components, i.e. to computer B and computer C, a status change message 102, which has the identifier StChID=6 (old StChID plus 1). The status owner is now computer A since the status change came from this computer. The MID for A is also incremented and transmitted with the status change message and now amounts to 16.

The message 102 is correctly received by all other components. The identifiers StChID and MID are compared with the locally stored values and it is established that the previous local status at B and C was valid since the received values for StChID and MID correspond exactly to the local values incremented by 1. It further follows from the fact that A has used the correct StChID and MID, that the status is also valid at computer A. Computers B and C then update the status of the object X, which is then identical again for all computers, with the parameters StChID=6, StOwn=A and MID A:16, B:20, C:35.

Expressed in more general terms, the system behaves in the error-free operation described here as follows:

All objects which represent a part of the system status are basically created on each of the computers involved. This means that all objects affected by a system status are replicated globally. Each change of status is sent by multicast message and thus received by all components or by computers A, B, C. The local object parameter StChID, the parameter StOwn and the local computer or local component parameter MID are inserted into such a message.

The parameter StChID can be used to detect conflicts caused by simultaneous status change or temporary network separation. Temporary network separations can be detected on the basis of the local computer parameter MID. Simultaneously this parameter can be regularly monitored by an active ping mechanism between the computers involved, with the ping mechanism being embodied such that pings can only be exchanged if no other messages of this computer have been received. If none of the monitoring mechanisms notifies an error, this means that the propagation of the status change by the simple sending out of the (multicast) message is at an end.

Again referring to FIG. 1, computer B transfers to al other components, i.e. to computer A and C, as a result of a status change, a status change message 104, which carries the identifier StChID=7 (old StChID plus 1). Status owner is now computer B, since the status change originates from this computer. The MID for B is also incremented and transmitted with the status change message and now amounts to 21.

The message 104 is received correctly by A. Computer A again performs the above-mentioned checks and finally the local status, which is then characterized by the parameters StChID=7, StOwn=B and MID A:16, B:21, C:35.

As a result of a communication fault the message 104 is not received or not correctly received by computer C. Computer C does not take any action and remains in the currently valid status, which—as above—is characterized by the parameters StChID=6, StOwn=A and MID A:16, B:20, C:35.

From this moment the distributed system is no longer synchronous, which however cannot be directly established. The error is detected in the example of FIG. 1 on the basis of the next status change message, but can also be detected by the ping mechanism mentioned. The error can be detected by ping by B sending out pings to A and C with the last valid MID, at which point C determines a deviation and thus identifies the local status as invalid, at which point error handling in the sense of FIG. 2 is undertaken.

If the error detection is undertaken in the system on the basis of the next status change message, two cases can be distinguished: C transmits a status change message, and A and B detect the problem (shown in FIG. 1, described below), or A or B transmit a status change message and C detects the problem (shown and described in conjunction with FIG. 2).

As a result of a status change computer C transmits a status change message 106 to all other components, i.e. to computers A and B. Since the local status of the object X in the computer C does not match the current status, C uses an old status change message—from the point of view of A and B—id. StChID=7. The status of C is recognized as invalid by A and B since an StChID=8 was expected by C.

If an error is detected, a conflict resolution is executed. In this case it is established with reference to the parameters StOwn, StChID or/and specifiable priorities by which component the true status was determined. With the same rights the component can be determined on the basis of a minimum of a generally known comparable characteristic to the actual status owner (e.g. on the basis of the network address). Since all the data needed for the decision is present globally, the decision can be made without additional communication.

In the example of FIG. 1 it is assumed that the parameter StOwn is decisive for determining the component which identifies the true status, i.e. computer B is selected as the component at which the last status change (with StChID=7) has occurred. From this selected component the complex object is transmitted at least to the component with the invalid local status, that is computer C (step 108) and can also be transmitted in parallel to all other components. The object X with the status StChID=7 is transmitted serialized by means of multicast (Serial X 7). If only the components with invalid local status are newly supplied with the object X, instead of multicast a transaction-secured transmission can also be selected to ensure that the object map was transmitted completely error-free.

After this error rectification all components A, B, C again have a uniform status with regard to the object X, characterized by the parameters StChID=7, StOwn=B and MID A:16, B:21, C:36.

FIG. 2 presents the case, starting from the same situation as FIG. 1 (A and B have StChID=7, C has StChID=6 because of an error) in which the inconsistency is established at component C, with the error rectification requiring more steps, because of the parallel events, than in the example of FIG. 1.

After component B in step 104 has transmitted a new status transmission (with StChID=7), there is a change of status at A which is transmitted from A to the other components, i.e. to the computers B and C (step 206). This is done by using the status change message parameters StChID

=8, StOwn=A and MID=17. On arrival of the StChID=8 in the received status change message C establishes that a status change message with StChID=7 was not received by C and thus that the local status at C is invalid. C therefore requests via a broadcast (i.e. to all components including a component D which has not thus far been considered for reasons of simplicity) by means of message 210 a current image of the object and starts a monitoring timer to monitor receipt of the image from A. Beforehand however B had already signalled a further status change by means of a status change message 208 (StChID=9, StOwn=B, MID=9) to all other components.

The status change message 208 is received by C, after which C establishes that a message from B has been lost since the local MID for B amounts to 20, whereas that contained in the received message is 22. If an MID deviates from the expected value no broadcast is sent to all other components but instead a complete list of all status change message identifiers StChID is requested from the partner component for which the MID shows deviations (step 214), which is received (step 218) and on the basis of which it is determined for which objects an updated image is to be requested. For these objects the image is then requested by broadcast, step 220.

In the case of FIG. 2, after receipt of the status change message 208 the requested image of the object X was transmitted from A to C (and optionally also to all other components) with Status ID 8 (step 212), with a further status change, initiated by D (step 216), being received before the complete receipt of this image at C. This status change 216 is buffered jointly with status change 208 at C in order to be able to adapt the received image. This would be necessary here since the image is of status 8, the message 208 is of status 9 and the message 216 of status 10. However with messages 214 and 218 the given list of the StChIDs has been requested and received, and a new object image is requested by broadcast, step 220. This broadcast is answered by D (step 222), since component D is the current status owner. The StChID of this object image is compared with the buffered status modification messages and their identifiers StChID and all buffered status change messages are rejected for which the StChID is less than or equal to the StChID of the image.

After this error rectification all components A, B, C, D again have a uniform status as regards the object X, characterized by the parameters StChID=10, StOwn=D and MID A:17, B:22, C:35, D:567.

It should be pointed out that with requests for object images by components which have detected an invalid local status, a timer is started as already mentioned, within which the object image of the status owner of the last status change message (on the basis of which the error was detected) is expected. If this is not sent, the component with the next lowest priority takes over this task. Advantageously this does not require any additional request, if object images are sent by broadcast to all components, since this is how the component with the next lowest priority establishes the absence of the object image from the actual status owner.

Alternatively the ping mechanism can be used to detect the failure of a status owner and to send the image of the object to the component with the invalid local status even before the timer has expired.

The maximum delay, with which the loosely-coupled distributed system in accordance with the present invention executes a synchronization depends on the value of the monitoring timer. This delay only has noticeably disruptive effect however in the event of an error so that transport networks of the prior art which even with insecure transmission exhibit a very low error quota overall enable a faster message transmission by means of simple, unconfirmed multicast messages in conjunction with the invention, with the high security of a completely transaction-secured system being achieved immediately after the expiry of the configurable time of the monitoring timer.

To execute the present invention any multicast mechanisms can be used, provided all components can be reached with multicast-messages. If for example the Internet Protocol IP is used as the preferred transport protocol and the User Datagram Protocol UDP is used as the multicast protocol, it must be ensured for example that all components are addressable, i.e., if the components lie in different IP networks, routers must be used for example and correspondingly reconfigured.

To represent devices which do not of themselves support any multicast mechanisms for status indication or a control of any number of sources, a representative object can be used. This representative object basically behaves like the objects described above. For direct access to the represented device however an object on a selected computer (as representative of the device) is defined which takes over the actual communication with the device. For determining this object the mechanisms described above are used, i.e. according to the minimum of a globally known computer characteristic one of the objects recognizes itself as representative object and sets an attribute with its computer address to notify this to the other objects. Should a number of objects simultaneously declare themselves to be a representative object, this status is resolved again by conflict resolution, as stated above. In order to ensure that there is only ever one representative object for a device, the monitoring function can be expanded such that, if a computer failure is established, all objects reset the now invalid attribute of the representative computer. Thereafter another representative object again takes over responsibility in accordance with the known algorithm. If the representative object receives (status) messages from the device represented It alters its status correspondingly. This is again transmitted automatically to all computers of the network.

Naturally algorithms other than the determination of a minimum given as an example can be used to select a conflict-resolution object or to select a representative object. Thus suitable algorithms can be used to effect a load distribution for this active object and its relevant representation on the computers involved.

To implement the present invention known programming characteristics can be applied to simplify the implementation of a system that can be described in this way. These especially include the use of reflection mechanisms for simple implementation of the information distribution, conflict detection and monitoring of the conflict resolution in basic classes which largely frees the higher layers of the implementation from realizing the specified mechanisms.

The system in accordance with the present invention is especially suitable for applications in which a number of consumers (e.g. operator workstations) with information of a data producer (e.g. sensor system) must be simultaneously provided with input without imposing an unnecessary additional load on the communication system. This is especially important with large numbers of producers and/or for data producers which generate large volumes of data. An important example of this are monitoring systems with a number of operator workstations which are also spatially separated and a multiplicity of different data producers such as video sources, contact sensors, proximity sensors, moisture sensors, smoke detectors etc.

1-13. (canceled)

14. A method for synchronizing components of a distributed system, comprising:
providing in each component an object representing a status of the distributed system;
signalizing a change of the status of the object in one of the components to all other components by a status change message;
checking the signalized status change by each of the other components regarding a local validity;
updating the status of the objects in the other components if the status change is locally valid;
determining a component with a valid status of the object if the status change is locally invalid, and
sending the valid status of the object at least to the components having an invalid status of the object; and
updating the status of the object in such components having received the valid status.

15. The method according to claim 14, wherein the status change messages are transmitted by means of unsecured multicasts.

16. The method according to claim 14, wherein each status change message is assigned at least one consecutive status change message identifier, an identifier of the status changing component, and a local message identifier of the sending component.

17. The method according to claim 15, wherein each status change message is assigned at least one consecutive status change message identifier, an identifier of the status changing component, and a local message identifier of the sending component.

18. The method according to claim 16, wherein
all components receiving a status change message compare a local status change message identifier which corresponds to the status change message identifier of the last status change message received at or sent from the relevant component, to the status change message identifier of the received status change message, in order to check the local validity of the status change signalized, and wherein
on inequality, a status-defining component is determined by which the status of the object of all other components is newly determined.

19. The method according to claim 17, wherein
all components receiving a status change message compare a local status change message identifier which corresponds to the status change message identifier of the last status change message received at or sent from the relevant component, to the status change message identifier of the received status change message, in order to check the local validity of the status change signalized, and wherein
on inequality, a status-defining component is determined by which the status of the object of all other components is newly determined.

20. The method according to claim 18, wherein the status-defining component is determined from the identifier of the status-changing component, the status change message indentifier, and a priority assigned to the components.

21. The method according to claim 19, wherein the status-defining component is determined from the identifier of the status-changing component, the status change message indentifier, and a priority assigned to the components.

22. The method according to claim 18, wherein a copy of the entire object is requested at the component sending the status change message by components at which it was established from the comparison that the local status of the object does not match the current status.

23. The method according to claim 19, wherein a copy of the entire object is requested at the component sending the status change message by components at which it was established from the comparison that the local status of the object does not match the current status.

24. The method according to claim 20, wherein a copy of the entire object is requested at the component sending the status change message by components at which it was established from the comparison that the local status of the object does not match the current status.

25. The method according to claim 21, wherein a copy of the entire object is requested at the component sending the status change message by components at which it was established from the comparison that the local status of the object does not match the current status.

26. A distributed system, comprising:
a plurality of components, each component having at least one object representing a status of the distributed system, wherein each component comprises:
a mechanism for signalizing a change of the status of the object to all other components by a status change message;
a mechanism for checking the local validity of the signalized status change;
a mechanism for updating the status of the object in response to the receipt of a locally valid status change message;
a mechanism for determining a component with valid status of the object; and
a mechanism for receiving the status of the object from the determined component in response to the receipt of a locally invalid status change message.

27. The system according to claim 26, wherein the mechanism for signalizing the change of the status of the object comprises an unsecured multicast mechanism.

28. The system according to claim 26, wherein the mechanism for signalizing the change to the status of the object comprises a mechanism for creating status change messages to which at least one consecutive status change message identifier, one identifier of the status-changing component and one local message identifier of the sending component is assigned.

29. The system according to claim 28, wherein each of the components further comprises:
a mechanism for storing a local status change message identifier, which corresponds to the status change message identifier of the last status change message received by or sent by the relevant component;
a mechanism for comparing the local status change message identifier with the status change message identifier of a received status change message, in order to check the local validity of the status change;
a mechanism for determining a status-defining component in case of inequality; and
a mechanism for redefining the status of the object of all other components by the component determined.

30. The system according to claim 29, in which the mechanism for determining a status-defining component on inequality comprises a mechanism for evaluating the following parameters: Identifier of the status-changing component, status change message identifier, and a priority assigned to the component.

31. The system according to claim 28, wherein each component (A, B, C, D) comprises a mechanism for requesting a copy of the entire object at the component initiating the status change message in accordance with the establishment of a deviation of the local status from the system-wide status of the object.

32. The system according to claim 26, wherein the object operates as a representative of one of the components, and wherein an attribute of the object is used for the representation.

33. A component for a distributed system, comprising:
a mechanism for signalizing a change of the status of the object to all other components by a status change message;
a mechanism for checking the local validity of the signalized status change;
a mechanism for updating the status of the object in response to the receipt of a locally valid status change message;
a mechanism for determining a component with valid status of the object; and
a mechanism for receiving the status of the object from the determined component in response to the receipt of a locally invalid status change message.
